(19) United States
(12) Patent Application Publication
(10) Pub. No.: US 2022/0272912 A1
(43) Pub. Date: Sep. 1, 2022

(54) TREATMENT UNIT AND SYSTEM

(71) Applicant: Pure Life Carbon Inc., Edmonton, Altera (CA)

(72) Inventor: Ryan James Rand, Blackfalds (CA)

(21) Appl. No.: 17/637,863

(22) PCT Filed: Aug. 21, 2020
(86) PCT No.: PCT/CA2020/051140

§ 371 Date: Feb. 24, 2022

Related U.S. Application Data
(60) Provisional application No. 62/895,410, filed on Sep. 3, 2019.

(51) Int. Cl. A01G 24/10; C05F 11/00

(52) U.S. Cl. CPC A01G 24/10; C05F 11/00

(57) ABSTRACT

Disclosed herein is a treatment unit comprising a housing and a mesh container. The housing has one or more than one inlet and one or more than one outlet. The mesh container is received in the housing and comprises a mesh surface with a plurality of holes therethrough. The mesh container is configured to receive a solid material and solution flowing into the housing through the inlet passes through the plurality of holes and contacts the solid material before flowing out of the housing through the outlet. The treatment unit may be used to produce treated biochar.

### TECHNICAL FIELD

The present disclosure is directed to a treatment unit and treatment system, and in particular to a biochar treatment unit and system.

### BACKGROUND

Biochar is a high-carbon, fine-grained residue that is generally produced by a pyrolysis process. Pyrolysis involves the direct thermal decomposition of biomass in the absence of oxygen thereby preventing combustion, which produces a mixture of solids (the biochar), liquid (bio-oil), and gas (syngas) products. Besides pyrolysis, torrefaction and hydrothermal carbonization process can also thermally decompose biomass to solid material.

Biochar offers a number of benefits for soil health. Many benefits are related to the porous nature of biochar, which may be effective at retaining both water and water-soluble nutrients. Biochar may also be used as a habitat for many beneficial soil microorganisms. Biochar can be designed with specific qualities to target distinct properties of soils. Biochar may improve water quality, reduce soil emissions of greenhouse gases, reduce nutrient leaching, reduce soil acidity, and reduce irrigation and fertilizer requirements. Biochar has also been found under certain circumstances to induce plant systemic responses to foliar fungal diseases and to improve plant responses to diseases caused by soilborne pathogens.

### SUMMARY OF INVENTION

According to a first aspect there is provided a treatment unit comprising a housing and a mesh container. The housing has one or more than one inlet and one or more than one outlet. The mesh container is received in the housing and comprises a mesh surface with a plurality of holes therethrough. The mesh container is configured to receive a solid material and solution flowing into the housing through the inlet passes through the plurality of holes and contacts the solid material before flowing out of the housing through the outlet.

The housing may comprise one or more than one sidewall, a bottom plate and a removable lid. The treatment may further comprise a ledge that extends around an internal surface of the one or more than one sidewall of the housing. The housing may be part of a housing unit and the housing unit may further comprise a frame for supporting the housing. The frame may comprise four vertically orientated legs and the housing may comprise four sidewalls with each sidewall positioned between two of the legs. The frame may further comprise four horizontally orientated base bars that extend around the bottom of the legs to support the housing unit on the ground.

The frame may further comprise four horizontally orientated crossbars that extend between the legs and are positioned below the four sidewalls of the housing. Two of the crossbars may be lower crossbars that are opposite each other and are positioned lower on the legs than the other two opposed crossbars that are upper crossbars. The frame may further comprise: a horizontally orientated central support bar extending between a center point of the two opposed lower crossbars; and one or more than one support crossbar extending between the two opposed upper crossbars and the central support bar. The bottom plate of the housing may be V-shaped and supported by the central support bar and the one or more than one support crossbar.

The central support bar may have a grove along its length and a centre line of the V-shaped bottom plate may be received in the groove. The one or more than one outlet may comprise two opposed outlet ports on two opposed sidewalls of the housing. The two opposed outlets ports may be positioned above the centre line of the V-shaped bottom plate.

The frame may comprise four horizontally orientated top bars that extend around the top of the sidewalls of the housing.

The one or more than one inlet may comprise a top inlet through the lid. The top inlet may be a diffusion cone or spray nozzle attached to an internal surface of the lid. The one or more than one inlet may further comprise one or more than one side inlet through the one or more than one sidewall.

The one or more than one sidewall of the housing may have an opening therethrough and the opening may be surrounded by a port housing on an external surface of the sidewall.

The mesh container may comprise a top mesh panel, a bottom mesh panel and one or more than one side mesh panel extending between the top mesh panel and the bottom mesh panel. There may be four side mesh panels extending between the top mesh panel and the bottom mesh panel. The mesh container may further comprise a frame to which the mesh panels are attached. The mesh panels may be removable attached to the frame. The mesh container may further comprise one or more than one lifting attachment configured for attachment to a lifting machine.

According to another aspect, there is provided a method of treating biochar in the treatment unit of the present disclosure, comprising:
loading the mesh container with the biochar and positioning the mesh container in the housing;
flowing solution into the housing through the one or more than one inlet such that the solution contacts the biochar in the mesh container; and
drawing solution out of the housing through the one or more than one outlet.

At least some of the solution drawn out of the housing through the one or more than one outlet may be recirculated back into the housing through the one or more than one inlet.

According to another aspect, there is provided a treatment system comprising a plurality of the treatment units of the present disclosure in series.

According to another aspect, there is provided a method of growing one or more plant, comprising planting the plant in the treated biochar obtained from the method of the present disclosure.

According to another aspect, there is provided a soilless growing medium comprising the treated biochar obtained from the method of the present disclosure.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

FIG. 1 is a perspective view of a housing unit according to a first embodiment comprising a frame supporting a housing comprising four sidewalls, a bottom plate and a removable lid.

FIG. 2 is a perspective view of the housing unit without the lid.

FIG. 3 is a perspective view of the housing unit without the lid. Two of the sidewalls are removed to show internal structures of the housing unit.

FIG. 4 is a perspective view of the housing unit without the lid. Two of the sidewalls and the bottom plate are removed to show internal structures of the housing unit.

FIG. 5 is a perspective view of the lid of the housing unit comprising four sidewalls and a top cover extending between the sidewalls.

FIG. 6 is a perspective view of the lid of the housing unit with the top cover removed to show internal structures of the lid.

FIG. 7 is a perspective view of a mesh container according to a first embodiment.

FIG. 8 is an expanded view of the mesh container.

FIG. 9 is a schematic of a treatment system comprising a plurality of treatment units.

FIG. 10 is a perspective view of a housing unit according to a second embodiment.

FIG. 11 is perspective view of the lid of the housing unit of the second embodiment comprising two lid sections.

FIG. 12 is a perspective view of one of the lid sections with the top cover removed to show internal structures of the lid section.

### DETAILED DESCRIPTION

Directional terms such as “top”, “bottom”, “upper”, “lower”, “left”, “right”, “vertical”, “horizontal”, “side” are used in the following description for the purpose of providing relative reference only, and are not intended to suggest any limitations on how any article is to be positioned during use.

Embodiments described herein relate to a treatment unit comprising a housing unit and a mesh container that is removable received within the housing unit. Further embodiments described herein relate to a treatment system comprising a plurality of treatment units.

The treatment unit and treatment system may be used to chemically and/or biologically inoculate biochar. Customized formulas may be added to optimize the function of biochar for various end uses of the treated biochar product. Examples of end uses of the treated biochar include, but are not limited to: soilless growing medium, soil augmentation, soil additive, animal feed supplementation, waste water filtration, drinking water filtration, pharmaceutical medium, animal bedding, compost additive, fish farm water filtration, medical supplement, health and beauty component, concrete additive, soil remediation additive, insulating material and carbon sequestration.

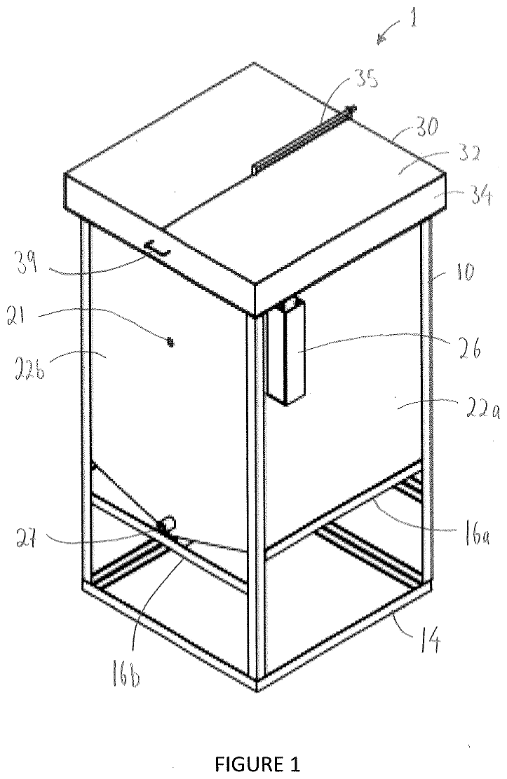

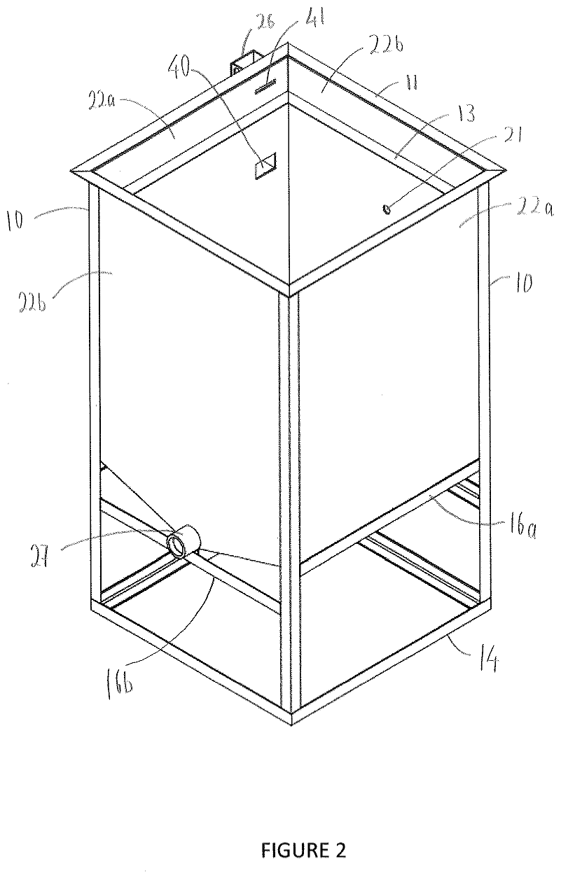

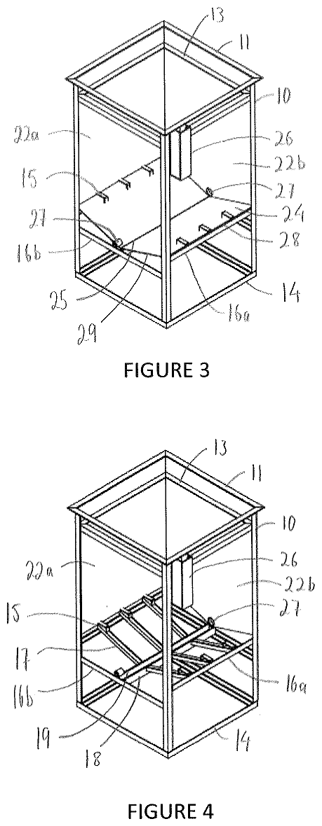

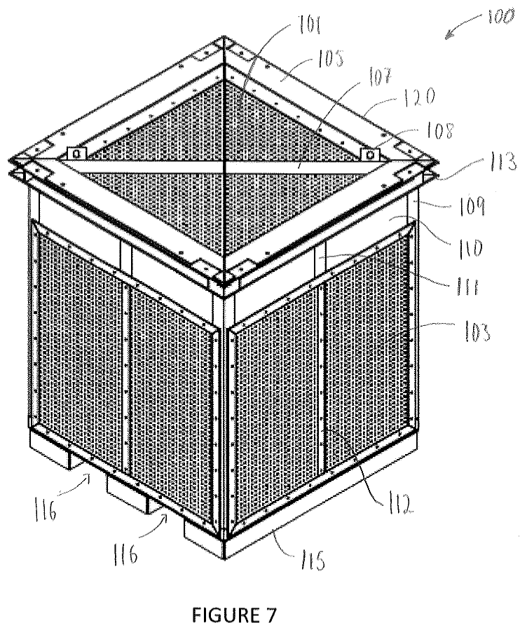

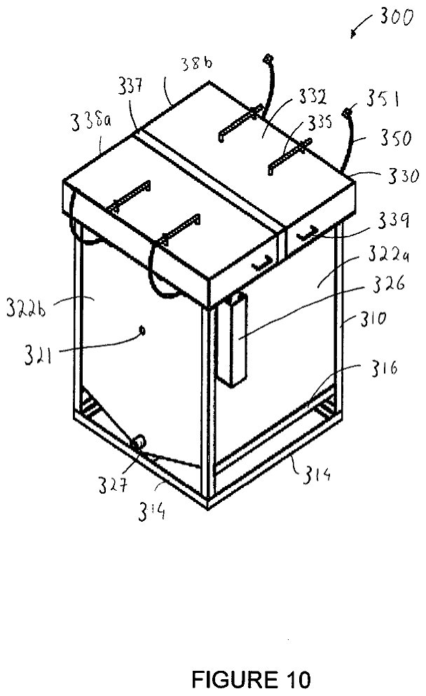

FIGS. 1-5 show a first embodiment of the housing unit 1. FIGS. 10-12 show a second embodiment of the housing unit 300. FIGS. 6-7 show an embodiment of the mesh container 100. The description below provides directional terms in relation to the housing unit 1 and mesh container 100 being in an upright position as shown in the figures.

As shown in FIGS. 1-4, the housing unit 1 comprises a frame supporting a housing. The frame comprises four vertically orientated legs 10 positioned at each corner of the housing unit 1. The legs 10 extend below the housing and four horizontally orientated base bars 14 extend around the bottom of the legs 10 and support the housing unit 1 when it is in an upright position on the ground. The length of the legs 10 may be chosen to accommodate use in facilities with different ceiling heights. In alternative embodiments (not shown), the legs 10 may be adjustable in order that they can be adjusted to different heights so that the housing unit 1 can be used in different facilities. The frame also includes four horizontally orientated crossbars that extend between the legs 10 and are positioned below the housing. Two of the crossbars 16b are opposite each other and are positioned lower on the legs 10 than the other two opposed crossbars 16a. A horizontally orientated central support bar 18 extends between a centre point of the two opposed lower crossbars 16b. The central support bar 18 has a grove 19 along its length. Three support crossbars 17 extend between each of the two opposed upper crossbars 16a and the central support bar 18. As the central support bar 18 is at a lower orientation relative to the upper crossbars 16a, the support crossbars 17 slope downwards towards the central support bar 18. Each of the support crossbars 17 has a flat wedge 15 at the end adjacent the upper crossbars 16a. The frame also includes four horizontally orientated flat top bars 11 that extend around the top of the legs 10 and provide a flange around the top of the housing. The configuration of the frame is such that forks of a forklift truck can be inserted between the base bars 14 and the lower crossbars 16b and the forklift truck can be used to lift and maneuver the housing unit 1 when needed. In alternative embodiments, the frame may be of a different configuration or may not be present at all.

The housing comprises four sidewalls, a bottom plate 24 and a removable lid 30. The bottom plate 24 comprises two panels joined along a central line 25. Each panel slopes downwards such that the bottom plate 24 is V-shaped with two opposed horizontally orientated edges 28 and two opposed V-shaped edges 29. The bottom plate 24 is supported by the central support bar 18 and support crossbars 17 of the frame with the central line 25 of the V-shaped bottom plate 24 received in the groove 19 of the central support bar 18. The bottom plate 24 has three cut out grooves along each of the two opposed horizontally orientated edges 28. The cut out grooves receive the wedges 15 of the support crossbars 17.

Two opposed sidewalls 22a of the housing are rectangular and extend between the two opposed horizontally orientated edges 28 of the bottom plate 24 and the top bars 11 of the frame. The other two opposed sidewalls 22b of the housing have a V-shaped bottom edge and extend between the two opposed V-shaped edges 29 of the bottom plate 24 and the top bars 11 of the frame. In alternative embodiments, the sidewalls and bottom plate of the housing may have a different configuration where the sidewalls and bottom plate join together to form a housing for receiving a solution. A ledge extends around the inside of the housing comprising four horizontally orientated ledge bars 13 that extend between the legs 10.

The housing includes two opposed outlet ports 27, with each outlet port 27 positioned near the V-shaped bottom edge of one of the two opposed sidewall 22b and above the central line 25 of the bottom plate 24. One of the sidewalls 22b includes an inlet port 21 for inflow of solution into the housing unit 1 as described below in more detail. In alternative embodiments (not shown) two or more sidewalls 22a, 22b may include an inlet port.

One of the sidewalls 22a of the housing unit 1 has an opening 40 therethrough surrounded by a port housing 26 comprising three sidewalls and a bottom wall. The top of the port housing 26 is open allowing access to the opening 40 so that probes, thermometers or other sensors can be dipped into the solution contained within the housing to measure parameters of the solution. An overflow port 41 is positioned above the opening 40 and is also surrounded by the port housing 26. In alternative embodiments, the opening 40 and port housing 26 may be positioned on one of the other sidewalls or may have an alternative configuration, or alternatively may not be present. In further alternative embodiments, the overflow port 41 may be positioned on one of the other sidewalls or may not be present.

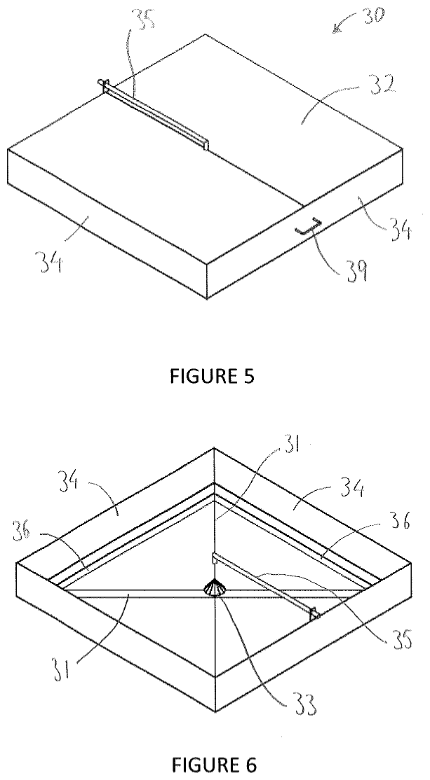

As shown in FIGS. 5 and 6, the lid 30 comprises four upper sidewalls 34, four lower sidewalls 36 and a top cover 32 extending between the upper sidewalls 34. A bottom edge of the upper sidewalls 34 slopes inwards and joins the four lower sidewalls 36 to provide an upper lid wall comprising the four upper sidewalls 34 and a lower lid wall comprising the four lower sidewalls 36. The lower lid wall is received within the top bars 11 of the frame to hold the lid 30 in position on the frame. Two crossbars 31 extend between opposite corners of the lid 30 and a diffusion cone 33 is attached to a central point of the crossbars 31 where the bars cross. A solution supply line 35 is attached to the top cover 32. The solution supply line 35 supplies solution to the diffusion cone 33 as discussed in more detail below. A handle 39 on one of the upper sidewalls 34 allows the lid 30 to be lifted off the frame by an overhead crane when needed. In alternative embodiments the lid may have a different configuration as would be understood by a person skilled in the art.

FIGS. 10-12 show a second embodiment of the housing unit 300. The housing unit 300 of the second embodiment is similar to the housing unit 1 of the first embodiment and comprises a frame supporting a housing. The frame comprises four vertically orientated legs 310 positioned at each corner of the housing unit 300. Four horizontally orientated base bars 314 extend around the bottom of the legs 310 and support the housing unit 300 when it is in an upright position on the ground. The frame also includes two horizontally orientated opposed crossbars 316 that extend between the legs 310. In alternative embodiments, the frame may be of a different configuration or may not be present at all.

The housing comprises four sidewalls, a bottom plate and a removable lid 330. The bottom plate (not shown) is V-shaped and similar to the bottom plate 24 of the housing unit 1 of the first embodiment described above. Two opposed sidewalls 322a of the housing are rectangular and the other two opposed sidewalls 322b of the housing have a V-shaped bottom edge similar to the sidewalls 22a, 22b of the housing unit 1 of the first embodiment described above. In alternative embodiments, the sidewalls and bottom plate of the housing may have a different configuration where the sidewalls and bottom plate are fitted together to form a housing for receiving a solution. The housing includes two opposed outlet ports 327, with each outlet port 327 positioned near the V-shaped bottom edge of one of the two opposed sidewall 322b. One of the sidewalls 322b includes an inlet port 321 for inflow of solution. In alternative embodiments (not shown) two or more sidewalls 322a, 322b may include an inlet port. One of the sidewalls 322a of the housing unit 300 has an opening therethrough (not shown) surrounded by a port housing 326 comprising three sidewalls and a bottom wall. The top of the port housing 326 is open allowing access to the opening so that probes, thermometers or other sensors can be dipped into the solution contained within the housing to measure parameters of the solution.

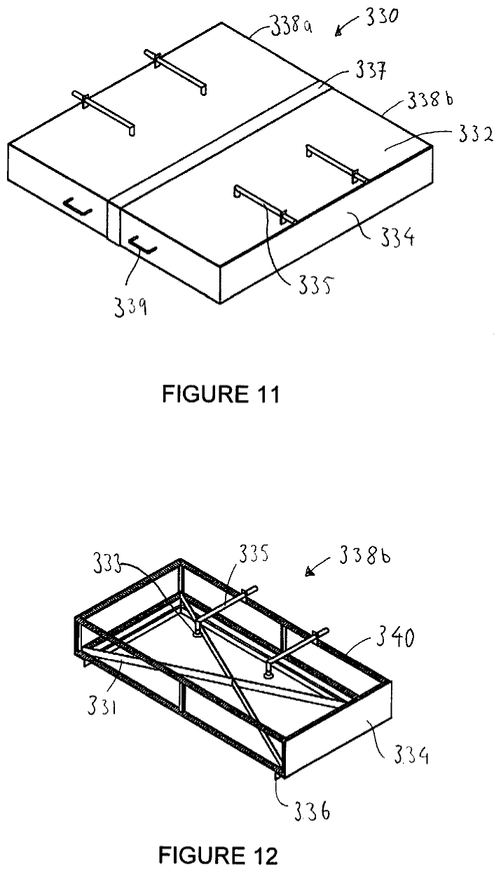

As shown in FIGS. 11 and 12, the lid 330 is made up of two lid sections 338a, 338b which overlap in an overlap section 337. Each lid section 338a, 338b comprises a rectangular lid frame 340 with a top cover 332 and sidewalls 334 extending around the outside edge of the lid frame 340. A lower lid wall 336 at the bottom of the lid frame 340 is received within top bars (not shown) of the frame of the housing unit 300 to hold the lid 330 in position on the housing unit frame. Two crossbars 331 extend between opposite corners of each of the lid sections 338a, 338b. Two solution supply lines 335 are attached to the top cover 332 of each lid section 338a, 338b and each solution supply line 335 passes through the top cover 332 and has a spray nozzle 333 in the internal space of the lid 330. The solution supply lines 335 supply solution to the spray nozzles 333 which spray solution onto the contents of the mesh container 100 as discussed in more detail below. A handle 339 on one of the sidewalls 334 of each lid section 338a, 338b allows the lid sections 338a, 338b to be lifted off the housing unit frame by hand when needed. A hinge (not shown) may be attached at one end to one of the sidewalls 334 of the lid and at the other end to the housing.

The two opposed sidewalls 322b of the housing each have two arms 350 attached near the top edge of the sidewalls 322b as shown in FIG. 10. The arms 350 have a flat support surface 351 at one end that supports the lid sections 338a, 338b when the lids are moved into an open position to allow access to the internal space of the housing unit 300. More specifically, a user lifts the handles 339 on the lid sections 338a, 338b to lift each lid section 338a, 338b upwards until the top cover 332 of each lid section 338a, 338b rests against the support surface 351 of the arms 350.

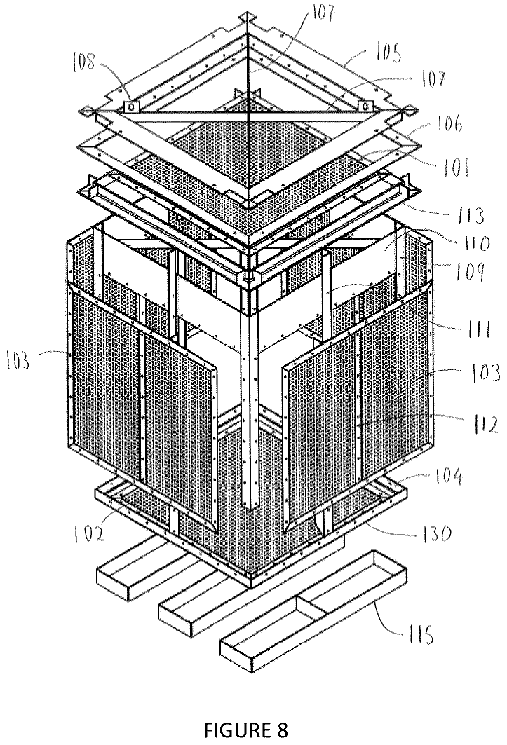

As shown in FIGS. 7 and 8, the mesh container 100 comprises a frame with a top mesh panel 101, a bottom mesh panel 102 and four side mesh panels 103 extending between the top mesh panel 101 and the bottom mesh panel 102. The bottom mesh panel 102 is part of a bottom plate 130 made up of four horizontally orientated bottom panel bars 104 joined together at each end to form a bottom frame with the bottom mesh panel 102 received within and fixed to the bottom frame. Three rectangular frames 115 are attached to the bottom panel bars 104 such that they are positioned below the bottom plate 130 with two gaps 116 extending along the length of the bottom plate 130 between the rectangular frames 115. These gaps 116 are configured to receive the forks of a forklift truck so that the forklift truck can be used to lift and maneuver the mesh container 100 during use.

The top mesh panel 101 is part of a lid 120 comprising an upper top frame and a lower top frame with the top mesh panel 101 fixed between the upper and lower top frames. The upper top frame comprises four top panel bars 105 joined together at each end, four top support bars 106 joined together at each end and two crossbars 107 extending between the corners of the four top panel bars 105. One of the crossbars 107 includes two lifting eyes 108 that can be used as attachments for a crane or the like for lifting the lid 120 allowing access to the inside of the mesh container 100 as described below in more detail. In alternative embodiments, additional lifting eyes or lugs or a different lifting attachment may be fixed to the lid 120 for attachment to a crane or other lifting machine. In further alternative embodiments, the lifting attachment may be on a side of the mesh container 100 and need not be on the lid. The lower top frame comprises four stiffening bars 113 joined together at each end.

The mesh container 100 also has a frame body that supports the side mesh panels 103. The frame body includes four vertically orientated corner bars 109, four horizontally orientated side panels 110 that extend between the four corner bars 109 and four vertically orientated central support bars 111. The top edge of each side mesh panel 103 is attached at several points to one of the side panels 110 of the frame body. Each side edge of the side mesh panels 103 is attached at several points to one of the corner bars 109 of the frame body. The bottom edge of each side mesh panel 103 is attached at several points to one of the bottom panel bars 104 of the bottom frame. Each side mesh panel 103 also includes a central vertically orientated attachment bar 112 that is attached at several points to one of the central support bars 111 of the frame body.

The mesh surface of the mesh panels 101, 102, 103 includes a plurality of holes therethrough. The holes are dimensioned to allow solution to pass through the holes while solid particles greater than the hole dimension are retained in the mesh container 100. For example, the holes may have a diameter of 0.1 mm to 1.5 mm or any diameter in between. Attachment of the mesh panels 101, 102, 103 to the frame of the mesh container 100 may be by nails, bolts or screws or other attachment means as known in the art. The attachments means may be a releasable to allow the mesh panels 101, 102, 103 to be removed from the frame and cleaned or replaced if they become damaged or if mesh panels with different sized holes therethrough are preferred for a particular treatment process. Alternatively, the mesh panels may be welded to the frame. In alternative embodiments, the mesh container may have a different configuration to the configuration shown in FIGS. 7 and 8 with at least a portion of the container comprising a mesh surface. For example, the mesh container may be cylindrical or pyramid shaped or any alternative shape.

In use, the lid 120 of the mesh container 100 can be removed by attaching a crane or other lifting mechanism to the lifting eyes 108 of the lid 120. Solid material to be treated, such as biochar, is placed in the mesh container 100 and the lid 120 is replaced on top of the mesh container 100 and fixed in position. The lid 120 may be attached to the frame of the mesh container 100 by bolts or screws or other attachment means.

In use, the lid 30, 330 of the housing unit 1, 300 can be removed by attaching a crane or other lifting mechanism to the handle 39, 339 of the lid 30, 330. Alternatively, the lid 30, 330 may be lifted by hand using the handle 39, 339. A crane or other lifting mechanism attached to the lifting eyes 108 of the lid 120 fixed in position on the mesh container 100 may be used to lift the mesh container 100 up and into the open housing unit 1, 300 and the lid 30, 330 may be positioned back on top of the housing unit 1, 300.

The four stiffening bars 113, four top panel bars 105 and four top support bars 106 of the lid 120 of the mesh container 100 form a flange that rests on the ledge bars 13 on the internal surface of the housing when the mesh container 100 is positioned inside the housing unit 1, 300. When the mesh container 100 is positioned within the housing unit 1, 300 there is a space between the bottom plate 130 of the mesh container 100 and the bottom plate 24 of the housing unit 1. There is also a space between the lid 120 of the mesh container 100 and the lid 30, 330 of the housing unit 1, 300. Furthermore, there is a space between the side mesh panels 103 of the mesh container 100 and the sidewalls 22a, 22b, 322a, 322b of the housing unit 1. In alternative embodiments the ledge bars 13 of the housing may not be present and the space between the bottom plate 130 of the mesh container 100 and the bottom plate 24 of the housing unit 1, 300 may be provided by the bottom of the mesh container 100 being supported by some other internal structure of the housing unit 100 that supports the mesh container 100.

In alternative embodiments, the housing of the housing unit need not comprise four sidewalls and may instead be made up of one sidewall or any number of sidewalls that join together to form the housing. In these alternative embodiments the mesh container need not comprise four side mesh panels and may instead be made up of one side mesh panel or any number of side mesh panels which correspond with the number of sidewalls of the housing.

A solution line (not shown) comprising tubing or some other conduit may be connected to each outlet port 27, 327, the inlet port(s) 21, 321, the solution supply line 35, 335, the diffusion cone 33, spray nozzles 333 and optionally one or more solution storage tanks (not shown), such that there is a flow path connecting the outlet ports 27, 327, inlet port(s) 21, 321, the diffusion cone 33, or spray nozzles 333 and optional solution storage tank(s). In alternative embodiments (not shown), there may be one or more solution nozzles positioned throughout the housing unit 1, 300 and/or mesh container 100 that are connected to the solution flow path for injecting solution against the contents of the mesh container 100. A pump (not shown) in the solution line pumps the solution around the flow path. More specifically, the pump draws solution from the bottom of the housing through the outlet ports 27, 327 and recirculates at least some of the solution back into the housing unit 1, 300 through the diffusion cone 33, or spray nozzles 333 and/or the inlet port(s) 21, 321. Solution injected from the diffusion cone 33, or spray nozzles 333 passes through the top mesh panel 101 and flows through the solid material contained in the mesh container 100. Solution may also be injected from one or more solution nozzles positioned throughout the housing unit 1, 300 and/or mesh container 100. A system of valves (not shown) connected to a controller may be provided in the solution line that control flow of the solution through the flow path. The controller may control if the valves are open or closed at any given time. The valves system may therefore beneficially provide increased circulation of solution and improved washing of the contents of the mesh container 100 as the direction of solution injected towards the solid material contained in the mesh container 100 may be switched regularly by opening and closing different valves in the solution line.

Once the solution has passed through the mesh container 100 it collects at the bottom of the housing in the space between the bottom plate 130 of the mesh container 100 and the bottom plate 24 of the housing. Some fine solid particles, such as dust particles from the biochar or the like, may be small enough to pass through the holes in the mesh panels 101, 102, 103. These solid particles settle under gravity along the central line 25 of the bottom plate 24. The outlet ports 27, 327 are positioned above the central line 25 of the bottom plate 24 to minimize the amount of solid particles that have settled on the bottom plate 24 being drawn out of the housing by the pump. Once the treatment process has been completed, the solid particles built up on the bottom plate 24 may be washed or sucked out of the housing through the outlet ports 27, 327 and disposed of. Furthermore, if during treatment the amount of solid particles built up on the bottom plate 24 goes above a predetermined level, the treatment unit may be shut down and the solid particles removed from the housing. A particulate sensor may be positioned in solution line that connects with the outlet ports 27, 327 to determine when the level of particulate material in the solution flowing out of the outlet ports 27, 327 has gone above a predetermine level. The particulate sensor can send a signal to a controller to shut down the treatment unit so that the built up solid matter can be removed from the housing.

The overflow port 41 of the housing unit 1 may be connected to an overflow line with an overflow sensor therein to detect if the level of solution goes above a predetermined level. The overflow sensor may be connected to a controller that can shut down the treatment unit if the level of solution goes above the predetermined level.

The solution used in the treatment process may be prepared on or off site. For example for treatment of biochar, the solution may comprise deionized water that has undergone reverse osmosis treatment. A reverse osmosis unit may be present on site or reverse osmosis treated water may be shipped from outside sources. Chemicals, biological material and/or microorganisms may be added to the reverse osmosis treated water in a solution preparation tank. For example, chemicals added to the solution may include one or more acids or alkaline to optimize the pH of the solution. Additionally or alternatively, one or more nutrients may be added to the solution, such as common nutrients for plants, animals and humans as would be known to a person skilled in the art. Beneficial microorganisms, such as microorganisms that help plant growth rate, human digestion, plant health, soil health or other beneficial biological additives may also be added to the solution.

During the treatment process, the solid material being treated, such as biochar, is washed by the solution. Nutrients, microorganisms and other chemicals contained in the solution may be absorbed by the solid material. It may be possible to alter the pH and/or nutrient content of the solid material through the treatment process to provide an optimal product for use in industry such as agriculture. In the case of biochar, the washing process removes and counteracts alkalinity from the external surface of the biochar product. Acids and/or nutrients, microorganisms and other chemicals added to the solution are absorbed into the porous biochar. When the treated biochar is used in agriculture, the acid and/or nutrients, microorganisms and other chemicals that have been absorbed into the biochar product may be released slowly over time and this may beneficially increase growth yields of crops that have been planted in the treated biochar. The crops may be planted directly into the treated biochar or the biochar may be added to soil and the crops planted into the biochar enriched soil. Crops grown in the treated biochar may also absorb some of the nutrients and other chemicals contained in the treated biochar which may provide enriched crops for consumption by animals or humans.

The levels of chemicals, nutrients, microorganisms and/or the pH of the solution used in the treatment process may be monitored using one or more sensors in the solution line, housing unit and/or sensors may be inserted into the solution through the opening 40 as discussed above. If the levels of nutrients, microorganisms and/or the pH of the solution goes outside a predetermined optimal range then additional chemicals and microorganisms may be added to the solution to bring the levels within the predetermined range. Monitoring of the solution composition may be done automatically and the data sent to a controller that analysis the data and initiates addition of chemicals to the solution if needed. Alternatively, a human operator may monitor the composition of the solution and add chemicals to the solution manually when needed. It may be beneficial to recirculate as much of the solution as possible through the treatment unit as the solution is typically expensive to make and may also be expensive to dispose of. Treatment of the solid material, such as biochar, in the treatment unit may be carried out in a pressure free or pressurized environment.

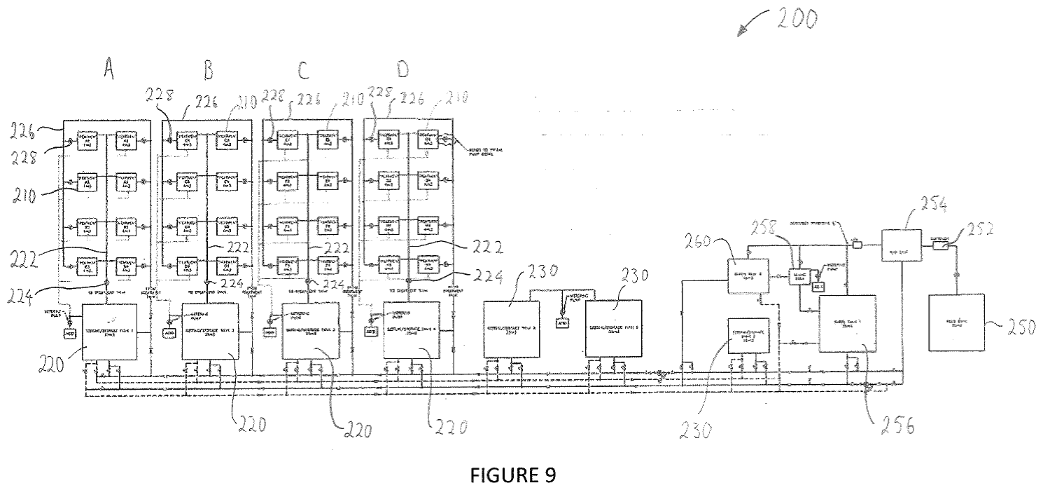

FIG. 9 shows an embodiment of a treatment system 200 comprising a plurality of treatment units 210 in series and equipment for preparing solution used in the treatment units 210.

There are four treatment sections A, B, C, D in the treatment system 200 shown in FIG. 9 and each treatment section A, B, C, D includes eight treatment units 210 and a solution storage tank 220. In alternative embodiments, there may be more or less treatment sections and any number of treatment units included in each treatment section. Each of the treatment units 210 may comprise the housing unit 1 and mesh container 100 as described above in connection with FIGS. 1-7. Solid material to be treated, such as biochar, is contained in the mesh container 100. A solution supply line 222 connects each solution storage tank 220 to the eight treatment units 210 in that section and a pump 224 in the solution supply line 222 pumps solution from the storage tank 220 to each of the treatment units 210 in that section. Solution enters each treatment unit 210 and washes the solid material contained in the mesh container as described in more detail above. A solution recirculation line 226 connects each of the treatment units 210 with the solution storage tank 220 and pumps 228 in the recirculation line 226 draw solution from the outlet ports of each of the treatment units 210 and the solution is pumped back to the storage tank 220.

The treatment system 200 may include a system of valves (not shown) controlled by a controller to open and close depending on the desired flow of the solution within the system. The pumps 224 and 228 may also be controlled by the controller. For example, the valves and pumps 224 may be configured to direct solution from the solution storage tank 220 to fill each treatment unit 210 in each treatment section A, B, C, D in turn. Each treatment unit 210 may then have a circulation stage where the solution is continuously added and removed from each of the treatment units 210 to wash the solid material in the treatment units 210. After sufficient time in the circulation stage, the valves and pumps 228 may be configured to draw solution from the treatment units 210 emptying each treatment unit 210 in the section in turn. This may be a continuous process with filling of the treatment units 210 starting again after the treatment units 210 have been emptied.

The storage tanks 220 may include UV filters (not shown) and other filters to keep the solution free from contaminants. There may also be pH sensors and other sensors in the storage tanks 220 that monitor the pH and composition of the solution in the storage tank 220. A particulate sensor may also be present in the storage tanks 220 to monitor the level of particulates in the solution. The data from these sensors may be sent to the controller which analysis the data. If the pH and nutrient composition of the solution is outside a predetermined optimal range, the controller may control addition of acid or alkaline to the solution to bring the pH of the solution within the optimal range and/or addition of nutrients until the optimal concentration of nutrients in the solution is achieved. If the level of particulates in the solution is above a predetermined level, the controller may activate shut down of the system so that the solution can be drained from the treatment units 210 and solid materials collected on the bottom of the treatment unit removed as discussed above in more detail.

The treatment system 200 includes three additional settling/storage tanks 230 where solution can be stored. Solution that has been used in the treatment of solid material in the treatment units 210 can be stored for a period of time in these settling/storage tanks 230 to allow any solid particles in the solution to settle at the bottom of the settling/storage tanks 230. The settling/storage tanks 230 may include or be connected to a filtration unit (not shown) for filtration and separation of the solid particles. The solution can then be recycled back into the system and the solid particles removed and disposed of. In alternative embodiments, there may be more or less additional settling/storage tanks or they may be no additional settling/storage tanks present in the system.

To prepare the solution used in the treatment units 210 water is pumped from a feed tank 250 to a reverse osmosis unit 254. If needed softener contained in a softener tank 252 may be added to the water before it enters the reverse osmosis unit 254. The water is deionized in the reverse osmosis unit 254 and then pumped into a first batch tank 256. In alternative embodiments, the water need not be deionized or filtered before use. Chemicals such as nutrients, acid or alkaline may be added in a mixing tank 258 as needed to make up the desired composition of the solution to be used in the treatment units 210 depending on the type of solid material being treated and the added chemicals or nutrients and resulting pH of the solid material desired. Microorganisms may also be added to the solution in the mixing tank 258. The mixing tank 258 may include a mixing hopper that mixes the chemicals and/or microorganisms evenly throughout the solution. The solution is then pumped from the mixing tank 258 to a second batch tank 260. The prepared solution can then be pumped to one of the settling/storage tanks 230 for storage until the solution is used for treatment of the solid material contained in the treatment units 210. Alternatively, the prepared solution may be pumped directly to the solution storage tanks 220 in the treatment sections A, B, C, D.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A treatment unit comprising:
a housing with one or more than one inlet and one or more than one outlet; and
a mesh container received in the housing, the mesh container comprising a mesh surface with a plurality of holes therethrough,
wherein the mesh container is configured to receive a solid material and solution flowing into the housing through the inlet passes through the plurality of holes and contacts the solid material before flowing out of the housing through the outlet.

2. The treatment unit of claim 1, wherein the housing comprises one or more than one sidewall, a bottom plate and a removable lid.

3. The treatment unit of claim 2, further comprising a ledge that extends around an internal surface of the one or more than one sidewall of the housing.

4. The treatment unit of claim 2, wherein the housing is part of a housing unit and the housing unit further comprises a frame for supporting the housing.

5. The treatment unit of claim 4, wherein the frame comprises four vertically orientated legs and the housing comprising four sidewalls with each sidewall positioned between two of the legs.

6. The treatment unit of claim 5, wherein the frame further comprises four horizontally orientated base bars that extend around the bottom of the legs to support the housing unit on the ground.

7. The treatment unit of claim 6, wherein the frame further comprises four horizontally orientated crossbars that extend between the legs and are positioned below the four sidewalls of the housing, wherein two of the crossbars are lower crossbars that are opposite each other and are positioned lower on the legs than the other two opposed crossbars that are upper crossbars, and the frame further comprises:
a horizontally orientated central support bar extending between a centre point of the two opposed lower crossbars; and
one or more than one support crossbar extending between the two opposed upper crossbars and the central support bar,
wherein the bottom plate of the housing is V-shaped and supported by the central support bar and the one or more than one support crossbar.

8. The treatment unit of claim 7, wherein the central support bar has a grove along its length and a centre line of the V-shaped bottom plate is received in the groove.

9. The treatment unit of claim 8, wherein the one or more than one outlet comprises two opposed outlet ports on two opposed sidewalls of the housing, wherein the two opposed outlets ports are positioned above the centre line of the V-shaped bottom plate.

10. The treatment unit of claim 4, wherein the frame comprises four horizontally orientated top bars that extend around the top of the sidewalls of the housing.

11. The treatment unit of claim 2, wherein the one or more than one inlet comprises a top inlet through the lid.

12. The treatment unit of claim 11, wherein the top inlet is a diffusion cone attached to an internal surface of the lid.

13. The treatment unit of claim 11, wherein the one or more than one inlet further comprises one or more than one side inlet through the one or more than one sidewall.

14. The treatment unit of claim 2, wherein the one or more than one sidewall of the housing has an opening therethrough and the opening is surrounded by a port housing on an external surface of the sidewall.

15. The treatment unit of claim 1, wherein the mesh container comprises a top mesh panel, a bottom mesh panel and one or more than one side mesh panel extending between the top mesh panel and the bottom mesh panel.

16. The treatment unit of claim 15, wherein there are four side mesh panels extending between the top mesh panel and the bottom mesh panel.

17. The treatment unit of claim 15, wherein the mesh container further comprises a frame to which the mesh panels are attached.

18. The treatment unit of claim 17, wherein the mesh panels are removable attached to the frame.

19. The treatment unit of claim 1, wherein the mesh container further comprises one or more than one lifting attachment configured for attachment to a lifting machine.

20. A treatment system comprising a plurality of the treatment units of claim 1 in series.

21. Use of a treatment unit for treating biochar, the treatment unit comprising:
a housing with one or more than one inlet and one or more than one outlet; and
a mesh container received in the housing, the mesh container comprising a mesh surface with a plurality of holes therethrough,
wherein the biochar is received in the mesh container and is treated by solution flowing along a flow path comprising the inlet, the outlet and the mesh container, wherein the flow path is configured such that the solution flows into the housing through the inlet, flows through the plurality of holes in the mesh container to contact the biochar, and flows out of the housing through the outlet.

22. The use of claim 21, wherein the treatment unit further comprises one or more than one valve in the flow path configured to control flow of solution through the flow path.

23. The use of claim 22, wherein the one or more that one valve is in communication with a controller configured to control opening and closing of the one or more than one valve.

24. The use of claim 21, wherein the flow path further comprises a solution line fluidly connecting the outlet with the inlet for recirculation of the solution from the outlet to the inlet.

25. The use of claim 24, wherein the treatment unit further comprises one or more than one pump for pumping the solution from the outlet to the inlet.

26. The use of claim 25, wherein the housing further comprises a bottom plate for collection of solid particles that are washed out of the biochar by the solution, wherein the outlet is positioned a predetermined height above the bottom plate.

27. The use of claim 26, wherein the treatment unit further comprises a particulate sensor in the solution line for determining when the level of solid particles in the solution from the outlet is above a predetermined level.

28. The use of claim 27, wherein the particulate sensor is in communication with a controller configured to shut down the treatment unit if the level of solid particles in the solution goes above the predetermined level.

29. The use of claim 25, wherein the treatment unit further comprises one or more than one valve in the flow path.

30. The use of claim 29, wherein the one or more than one pump and the one or more than one valve are in communication with a controller configured to control flow of solution along the flow path.

31. The use of claim 21, wherein the treatment unit further comprises one or more than one sensor in the flow path for monitoring the solution flowing along the flow path.

32. The use of claim 31, wherein the one or more than one sensor measures pH, nutrient levels and/or microorganism levels in the solution.

33. The use of claim 32, wherein the one or more than one sensor is in communication with a controller configured to receive and analyze data from the one or more than one sensor.

34. The use of claim 33, wherein the controller is configured to initiate addition of chemicals, nutrients and/or microorganisms to the solution as required based on the data received from the one or more than one sensor.

35. A method of treating biochar in a treatment unit, the treatment unit comprising:
a housing with one or more than one inlet and one or more than one outlet; and
a mesh container received in the housing, the mesh container comprising a mesh surface with a plurality of holes therethrough,
wherein the method comprises:
placing the biochar in the mesh container;
treating the biochar by flowing solution along a flow path comprising the inlet, the outlet and the mesh container, wherein the flow path is configured such that the solution flows into the housing through the inlet, flows through the plurality of holes in the mesh container to contact the biochar, and flows out of the housing through the outlet.

36. The method of claim 35, wherein the treatment unit further comprises one or more than one valve in the flow path, and the method further comprises controlling flow of solution through the flow path using the one or more than one valves.

37. The method of claim 36, wherein the one or more that one valve is in communication with a controller configured to control opening and closing of the one or more than one valve.

38. The method of claim 35, wherein the flow path further comprises a solution line fluidly connecting the outlet with the inlet, and the method further comprises recirculating the solution from the outlet to the inlet.

39. The method of claim 38, wherein the treatment unit further comprises one or more than one pump, and the method further comprises pumping the solution from the outlet to the inlet.

40. The method of claim 39, wherein the housing further comprises a bottom plate, and the method further comprises collecting solid particles washed out of the biochar by the solution, wherein the outlet is positioned a predetermined height above the bottom plate.

41. The method of claim 40, wherein the treatment unit further comprises a particulate sensor positioned in the solution line, and the method further comprises using the particulate sensor to determine when the level of solid particles in the solution from the outlet is above a predetermined level.

42. The method of claim 41, wherein the particulate sensor is in communication with a controller configured to shut down the treatment unit if the level of solid particles in the solution goes above the predetermined level.

43. The method of claim 39, wherein the treatment unit further comprises one or more than one valve in the flow path.

44. The method of claim 43, wherein the one or more than one pump and the one or more than one valve are in communication with a controller configured to control flow of solution along the flow path.

45. The method of claim 35, wherein the treatment unit further comprises one or more than one sensor positioned in the flow, and the method further comprises using the one or more than one sensor to measure pH, nutrient levels and/or microorganism levels in the solution.

46. The method of claim 45, wherein the one or more than one sensor is in communication with a controller configured to receive and analyze data from the one or more than one sensor.

47. The method of claim 46, further comprising adding chemicals, nutrients and/or microorganisms to the solution as required based on the data received from the one or more than one sensor.

48. A soilless growing medium comprising the treated biochar obtained from the method of claim 35.

49. A method of growing one or more than one plant, comprising planting the one or more than one plant in the soilless growing medium of claim 48.
